(19) United States
(12) Patent Application Publication
(10) Pub. No.: US 2012/0267462 A1
(43) Pub. Date: Oct. 25, 2012

(54) Grater For Single-Handed Operation

(75) Inventor: Patrick WAIBEL, Hong Kong (HK)

(73) Assignee: MAXPAT TRADING & MARKETING (FAR EAST) LTD., Hong Kong (HK)

(21) Appl. No.: 13/448,813

(22) Filed: Apr. 17, 2012

(30) Foreign Application Priority Data
Apr. 20, 2011 (GB) 1106707.1

(51) Int. Cl. A47J 43/25; B02C 19/20

(52) U.S. Cl. 241/168

(57) ABSTRACT

A grater for single-handed operation has a handle adapted to be grasped by the fingers, and a plunger adapted for engagement with the thumb. The plunger is slidingly received in an opening extending longitudinally through the handle, with a spring urging it to an extended position. A grating cutter and a cooperating holder for locating a food item adjacent the grating cutter are both disposed in a cavity within the handle. A detachable container for holding the food item encloses a resiliently-biased pusher for urging the food item toward the grating cutter, and reciprocating the plunger causes relative movement between the grating cutter and the holder.

### TECHNICAL FIELD

The present invention relates to graters, such as kitchen graters which may be operated single-handedly.

### BACKGROUND OF THE INVENTION

The prior art is replete with hand-held graters and mills for dispensing freshly grated condiments such as pepper and nutmeg. However, there remains a need for an improved grater which can be readily operated single-handedly. Some of the drawbacks of old graters, in addition to manufacturing cost and complexity, include exposed blades which may pose some risk to users, an unsuitability for table-top use due to their shape, bulky design (which also makes storage problematic), poor aesthetics and non-intuitive operation. For instance, U.S. Pat. No. 594,424 describes a grater for single-handed use that has a T-shape, comprising an elongate handle arranged perpendicular to an elongate blade and plunger assembly. It is an object of the present invention to overcome or substantially ameliorate the above disadvantages or more generally to provide an improved kitchen grater.

### DISCLOSURE OF THE INVENTION

According to one aspect of the present invention there is provided a grater for single-handed operation, comprising:

a handle adapted to be grasped by the fingers;

a plunger-receiving opening extending longitudinally through the handle;

a plunger slidingly received in the plunger-receiving opening, the plunger having a thumb-engaging surface adapted to be engaged by the thumb;

resilient means urging the plunger to an extended position;

a grating cutter;

a holder for locating a food item adjacent the grating cutter;

a resiliently-biased pusher for closing the holder and urging the food item toward the grating cutter;

a pusher retainer for retaining and guiding movement of the pusher, and wherein the plunger is connected to one of the holder and the grating cuter, and the other of the holder and the grating cutter mounted to the handle, such that reciprocating the plunger causes relative movement between the grating cutter and the holder.

Preferably, the grating cutter is recessed within the handle.

Preferably, the handle has longitudinally opposing first and second ends, the grating cutter and holder are disposed proximate the first end of the handle, and in the extended position the plunger extends from the second end of the handle.

Preferably, the first end includes first means defining a first plane transverse to a longitudinal axis of the handle for supporting the handle upright on a horizontal surface.

Preferably, the first means comprises a first transverse face.

Preferably, the second end includes second means defining a second planar face transverse to a longitudinal axis of the handle for supporting the handle inverted on a horizontal surface.

Preferably, the thumb-engaging surface is transverse and comprises the second means.

Preferably, the handle comprises a tubular member and the first transverse face is annular.

Preferably, the handle further comprises a block fixed internally to the tubular member, the plunger-receiving opening extending through the block.

Preferably, the resilient means comprises a plunger spring of helical form, the plunger comprises a button on which the thumb-engaging surface is disposed, a recess in the button receiving the plunger spring, opposing ends of the plunger spring abutting the button and the handle.

Preferably, the pusher retainer comprises an elongate linearly extending member.

Preferably, the linearly extending member comprises a cylindrical wall.

Preferably, the pusher retainer comprises a container with the cylindrical walls, opposing open and closed ends, and wherein a pusher spring is received in the container adjacent the pusher, the pusher spring urging the pusher toward the open end.

Preferably, the open end is tapered inwardly toward its end to retain the pusher in the container.

Preferably, the holder comprises a space disposed adjacent the grating cutter, and the container includes coupling means for connecting the guide means to the holder.

Preferably, the coupling means is selected from one of: a) at least one nub for engaging a slot of a bayonet joint for providing push-and-turn connection of the container to the holder and b) a first screw thread for engaging a second complementary screw thread on the holder.

Preferably, the holder is fixed to the plunger, and the grating cutter is fixed to the handle, and the container projects through a transverse aperture in the handle, the transverse aperture being elongated in the longitudinal direction.

Preferably, the holder is fixed to the handle, and the grating cutter is fixed to the plunger.

Preferably, the handle comprises a tubular member with an axis;

a recess is disposed in the first end of the tubular member, wherein the recess is defined by two parallel edges that intersect with a circumferential edge that is disposed in a second plane of the tubular member transverse to the axis, and the two parallel edges extend axially to a first transverse plane proximate the first end of the tubular body;

the holder comprises a block received in the recess;

a space is formed in the holder for receiving the food item, said space is defined by a cylindrical wall projecting from the tubular member, the cylindrical wall extending from an inner end adjacent the grating cutter to an outer end in which the pusher retainer is received into the space, the cylindrical wall having an internal screw thread adapted to couple with a complementary external screw thread on the pusher retainer;

wherein the block comprises an external surface of like curvature to the tubular member, and the cylindrical wall which extends tangentially to surfaces of the tubular member adjacent the parallel edges, the block further comprises a supporting surface in a plane transverse to a longitudinal axis of the handle for supporting the handle upright on a horizontal surface.

Preferably, the pusher retainer is operable to adjust the space defined by the grating cutter, the holder and the pusher.

This invention provides a grater which is effective and efficient for single-handed use, and which may be economically manufactured. The grating cutter is completely recessed for safety. The grater is adapted for table-top use as it can sit on the table in the orientation in which it is readily grasped making its operation intuitive. Moreover, it provides an aesthetically pleasing design with a slim profile for ready storage.

### BRIEF DESCRIPTION OF THE DRAWINGS

Preferred forms of the present invention will now be described by way of example with reference to the accompanying drawings, wherein:

FIG. 1 is a front view of a grater according to a first embodiment of the present invention;

FIG. 2 is a side view of the plunger of the grater of FIG. 1;

FIG. 3 is a longitudinal sectional view through the grater of FIG. 1;

FIG. 4 is a plan view of the grater of FIG. 1;

FIG. 5 is a front view of a grater according to a second embodiment of the present invention;

FIG. 6 is a longitudinal sectional view through the grater of FIG. 5;

FIG. 7 is a side view of the plunger of the grater of FIG. 5;

FIG. 8 is a bottom view of the grater of FIG. 5;

FIG. 9 is a side view of the grater of FIG. 5; and,

FIG. 10 is a side view of the grater of FIG. 5 with the block removed.

### DESCRIPTION OF THE PREFERRED EMBODIMENTS

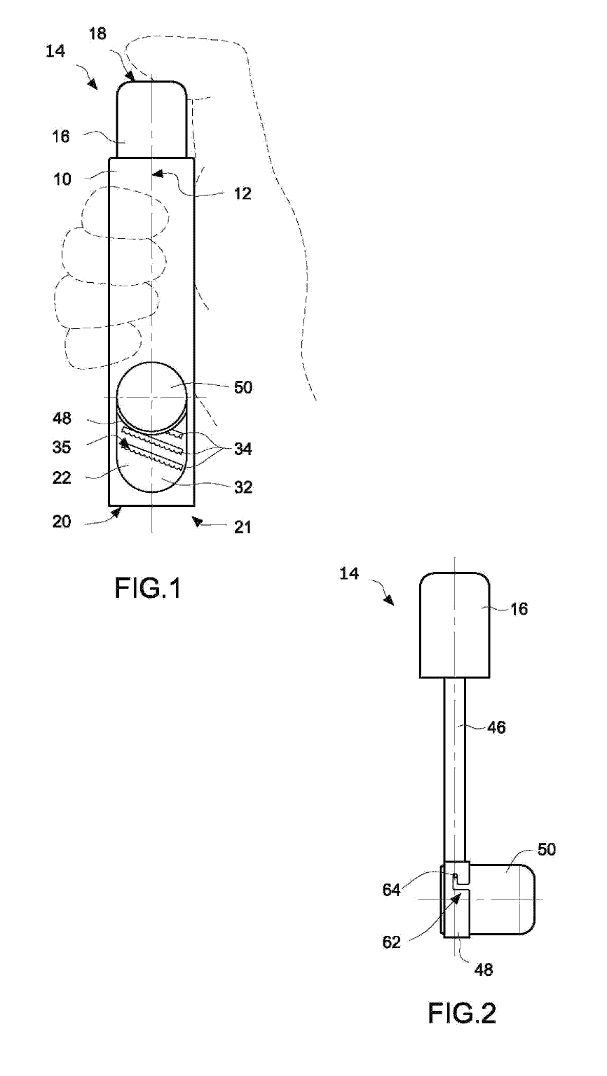

The present invention refers to a grater for single-handed operation. FIGS. 1-4 refer to a first embodiment of the grater. Referring to the drawings, the first embodiment includes a tubular handle 10 sized be grasped by the fingers, as shown in FIG. 1, and having a longitudinal axis 12. The tubular walls of the handle have an annular transverse face 20 at a first end 21 which may support the handle upright on a horizontal surface. A transverse aperture 22 is provided in first end 21, spaced apart from the transverse face 20. The tubular walls of the handle 10 may be imperforate, apart from the transverse aperture 22. The aperture 22 is obround, elongated in the direction of the long axis 12.

A block 24 is fixed internally to the tubular walls of the handle 10, with a plunger-receiving opening 26 extending axially through the block 24. The block 24 has a planar face 28 that bounds a cavity 30 in the first end 21. The block 24 includes a concavity 36 at a second end 23 of the handle 10, the recess having cylindrical inner sides coaxial with axis 12. An annular channel 38 is disposed at one end of the concavity 36. A ring 40 fixed to the tubular handle walls abuts one axial end of the block 24.

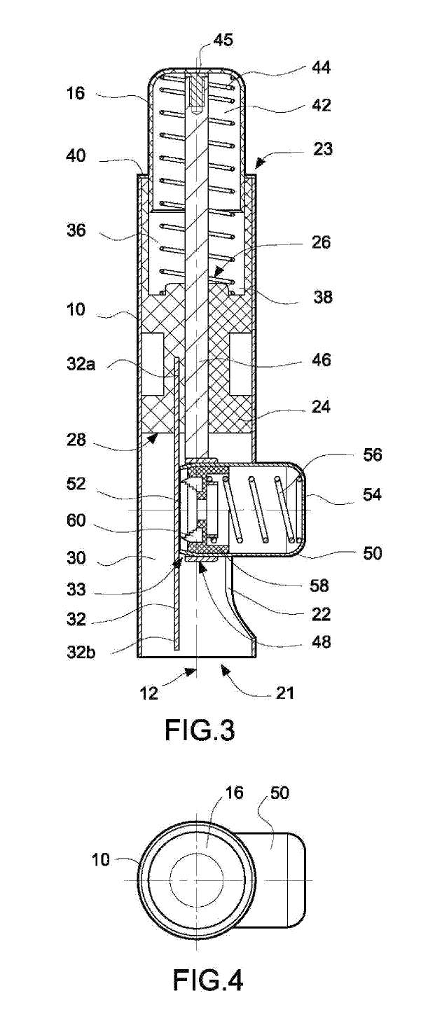

A grating cutter 32 recessed within in the cavity 30 is fixed to the handle 10. As shown in FIG. 3, the first embodiment of the grater having one end 32a of the grating cutter 32 fixed in a slot in the block 24, while the opposing end 32b is disposed proximate the transverse face 20. The grating cutter 22 may be generally planar, and is aligned parallel to the axis 12. The grating cutter 32 may comprise channels 34 as shown, with teeth 35 spaced apart along one side of each channel 34, although of course the cutting teeth is not material to the invention.

A plunger 14 is received in the handle 10, and includes a button 16 projecting through the second end 23. The button 16 has cylindrical walls coaxial with axis 12 and slidingly received within the concavity 36. The button 16 has a thumb-engaging surface 18 for engaging the thumb of a user, and which can also support the grater when inverted. A recess 42 in the button 16 receives and abuts one end of a helical compression spring 44, the opposing end being received in the annular channel 38 abutting the block 24, such that the spring 44 urges the plunger to the extended position shown in the drawings. The plunger 14 further includes a shaft 46 that extends axially through the opening 26 in the block 24, which thus provides a sliding bearing supporting the plunger 14. As shown in FIG. 3, one end of the shaft 46 is fixed to the button 16 as by a fastener 45, and the other end is fixed to a holder 48 disposed in the cavity 30. The holder 48 is ring-shaped, enclosing a space 33 disposed adjacent the grating cutter 32.

A helical pusher spring 56 and pusher 58 are received in a pusher retainer container 50, which has cylindrical walls which serve to contain and guide the pusher 58, restraining it to move linearly. The container 50 has opposing open and closed ends 52, 54. The pusher spring 56 abuts the closed end 54 and urges the pusher 58 toward the open end 52, which may be tapered inwardly to retain the pusher 58 and to assist entry of the open end 52 into the holder 48. Teeth 60 project from the outer side of the pusher 58 to engage the food item. While the holder 48 is the primary device for storing and retaining the food item to be grated, the container 50, in addition to holding a food item to be grated (not shown), may also serve as a secondary device for retaining food items inserted into the container by displacing the pusher 58 toward the closed end 54.

As shown in FIG. 2, on diametrically opposing sides of the holder 48 are generally L-shaped slots 62, each with an axially extending length having an open mouth, and a circumferential length terminating in a blind end. Nubs 64 project from the outer, opposing sides of the container 50 near the open end 52. The open end 52 is received in the complementary space in the holder 48, the container 50 extending through the transverse opening 22. Nubs 64 and L-shaped slots cooperate to provide a push-and-turn coupling of the bayonet type connecting the container 50 to the holder 48.

In use, the grater can be supported upright on a horizontal surface such as a table. When supported in this way it can be conveniently grasped as shown in FIG. 1 with the fingers extending about the handle 10 and the thumb engaging the plunger 14. Maintaining this grip, and with the grater upright, alternately pressing and releasing the plunger 14 reciprocates the food item in the container 50 relative to the grating cutter 32 to thereby dispense the grated food. To refill the container 50, it is removed and, with the holder 48 opening upwards, food is placed in the holder 48, before entering the end of the container 50 into the holder 48 and re-coupling the container 50 in the known manner. Alternatively, the container 50 may be held with the mouth 52 uppermost, the food placed in the open end 52 onto the pusher 58, before pushing the holder 48 over the container and turning to make the connection. Completely recessing the grating cutter 32 within the cavity 30 allows unintentional contact with the cutter to be avoided, so a sharp blade with fine cutting edges may be used.

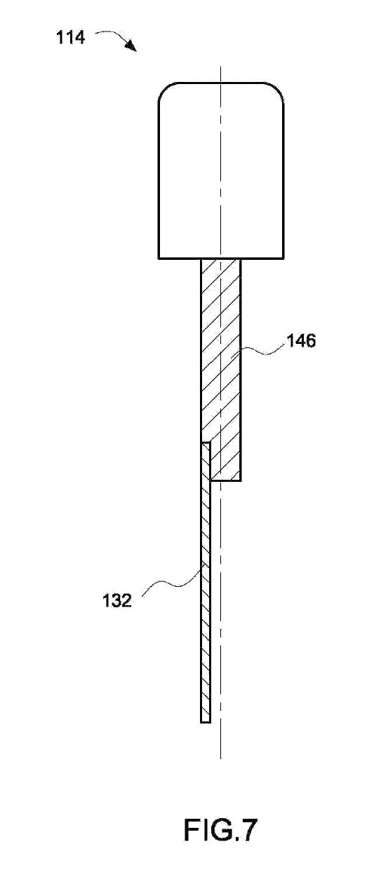

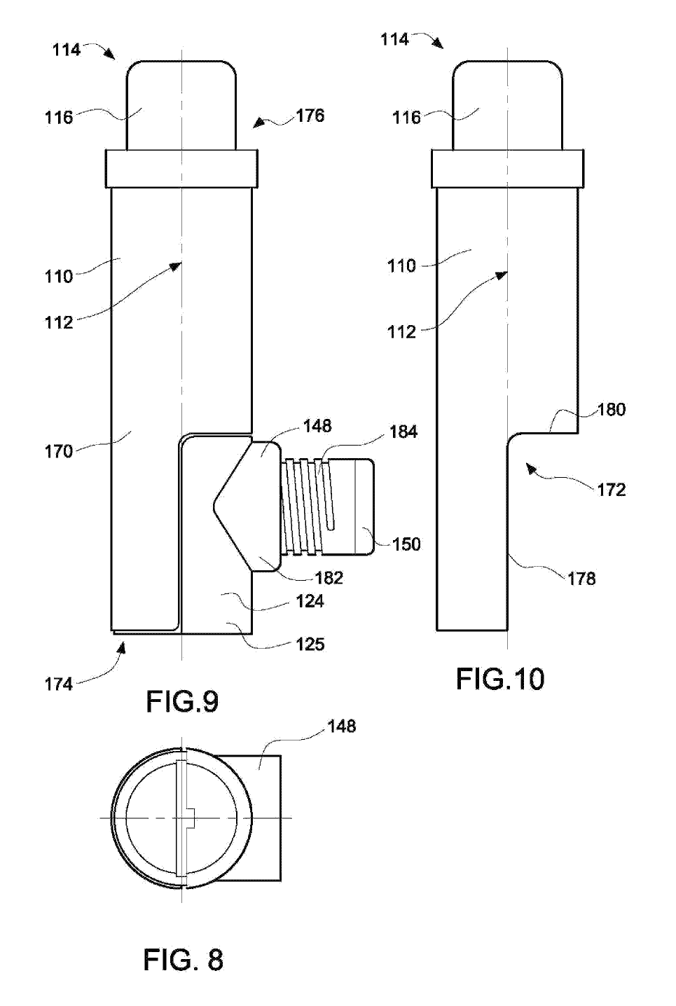

FIGS. 5-9 refer to a second embodiment of the grater. Referring to the drawings, the second embodiment includes a plunger 114 similar to the plunger 14 of the first embodiment but instead of connecting to the holder 48, the plunger 114 is connected to the grating cutter 132. The holder 148 is mounted to the handle 110. Reciprocating the plunger 114 and the attached grating cutter 132 by pressing on the thumb-engaging surface 118 of the button 116, the user causes relative movement between the grating cutter 132 and the holder 148, consequently allowing the food item to be grated.

As shown in FIGS. 9 and 10, the handle 110 may comprise a tubular member 170. The tubular member further comprises a recess 172 in the first end 174 of the tubular member 170. The recess 172 is defined by two parallel edges 178 (only one edge of the two parallel edges is shown in FIG. 10) that intersect with a circumferential edge 180 that is disposed from a second plane transverse to the axis 112 of the tubular body 170. The two parallel edges 178 also extend axially to a first transverse plane proximate the first end 174 of the tubular body 170. A block 124 is received in the recess 172.

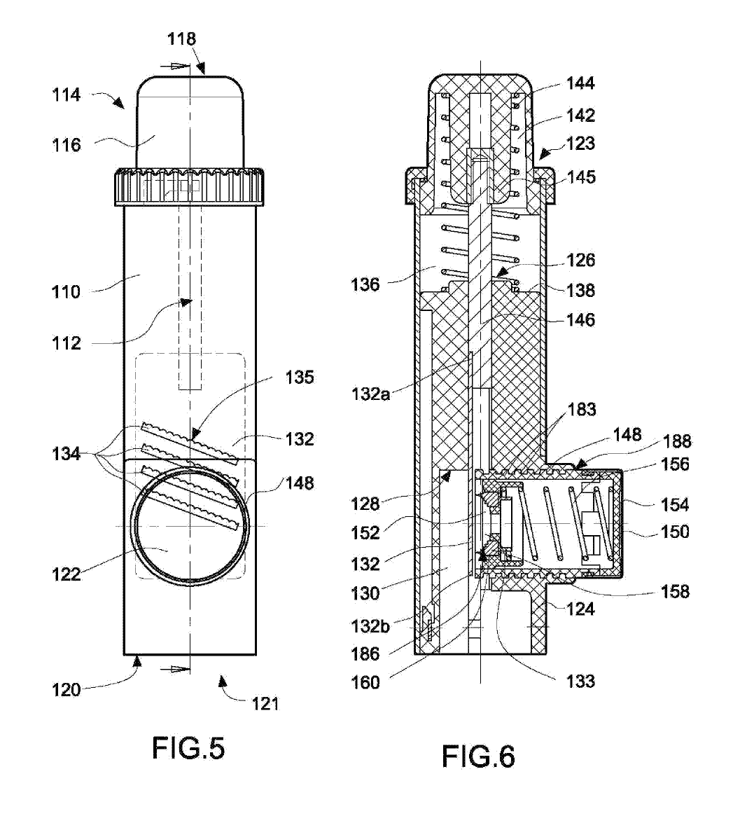

The holder 148 may comprise a space 133 for receiving the food item. The space 133 is defined by a cylindrical wall 182 projecting from the tubular member 170. The cylindrical wall 182 may further comprise an internal screw thread 183 best seen in FIG. 6 for coupling with a complementary external screw thread 184 on the pusher retainer 150.

The pusher retainer 150 maybe operable to adjust the size of the space defined by the grating cutter 132, the cylindrical wall 182 and the pusher 158, that is, by screwing the pusher retainer 150 in and out of the space its size varied. This allows further space in the holder so that more food items can be enclosed and grated, without the need of frequent refilling of food items.

The block 124 may be a moulded polymer component that further comprise an external surface 125 of like curvature to the tubular member 170, an external cylindrical wall 182 which extends tangentially to surfaces of the tubular member 170 adjacent the parallel edges 178. The block may also comprise an internal cylindrical wall bounding the space 133. The internal cylindrical wall extends from an inner end 186 adjacent the grating cutter 132 to a mouth at an outer end 188 in which the pusher retainer 150 is received into the space 133.

The block 124 may further comprise a support surface 120 transverse to a longitudinal axis 112 of the handle 110 for supporting the handle 110 upright on a horizontal surface such as a table.

Aspects of the present invention have been described by way of example only and it should be appreciated that modifications and additions may be made thereto without departing from the scope thereof.

1. A grater for single-handed operation, comprising:
a handle adapted to be grasped by the fingers;
a plunger-receiving opening extending longitudinally through the handle;
a plunger slidingly received in the plunger-receiving opening, the plunger having a thumb-engaging surface adapted to be engaged by the thumb;
resilient means urging the plunger to an extended position;
a grating cutter;
a holder for locating a food item adjacent the grating cutter;
a resiliently-biased pusher for closing the holder and urging the food item toward the grating cutter;
a pusher retainer for retaining and guiding movement of the pusher, and wherein the plunger is connected to one of the holder and the grating cuter, and the other of the holder and the grating cutter mounted to the handle, such that reciprocating the plunger causes relative movement between the grating cutter and the holder.

2. The grater of claim 1 wherein the grating cutter is recessed within the handle.

3. The grater of claim 1 wherein the handle has longitudinally opposing first and second ends, the grating cutter and holder are disposed proximate the first end of the handle, and in the extended position the plunger extends from the second end of the handle.

4. The grater of claim 3 wherein the first end includes first means defining a first plane transverse to a longitudinal axis of the handle for supporting the handle upright on a horizontal surface.

5. The grater of claim 4 wherein the first means comprises a first transverse face.

6. The grater of claim 3 wherein the second end includes second means defining a second planar face transverse to a longitudinal axis of the handle for supporting the handle inverted on a horizontal surface.

7. The grater of claim 6 wherein the thumb-engaging surface is transverse and comprises the second means.

8. The grater of claim 5 wherein the handle comprises a tubular member and the first transverse face is annular.

9. The grater of claim 8 wherein the handle further comprises a block fixed internally to the tubular member, the plunger-receiving opening extending through the block.

10. The grater of claim 1 wherein the resilient means comprises a plunger spring of helical form, the plunger comprises a button on which the thumb-engaging surface is disposed, a recess in the button receiving the plunger spring, opposing ends of the plunger spring abutting the button and the handle.

11. The grater of claim 1 wherein the pusher retainer comprises an elongate linearly extending member.

12. The grater of claim 11 wherein the linearly extending member comprises a cylindrical wall.

13. The grater of claim 12 wherein the pusher retainer comprises a container with the cylindrical walls, opposing open and closed ends, and wherein a pusher spring is received in the container adjacent the pusher, the pusher spring urging the pusher toward the open end.

14. The grater of claim 13 wherein the open end is tapered inwardly toward its end to retain the pusher in the container.

15. The grater of claim 13 wherein the holder comprises a space disposed adjacent the grating cutter, and the container includes coupling means for connecting the guide means to the holder.

16. The grater of claim 15 wherein the coupling means is selected from one of: a) at least one nub for engaging a slot of a bayonet joint for providing push-and-turn connection of the container to the holder and b) a first screw thread for engaging a second complementary screw thread on the holder.

17. The grater of claim 1 wherein the holder is fixed to the plunger, and the grating cutter is fixed to the handle, and the container projects through a transverse aperture in the handle, the transverse aperture being elongated in the longitudinal direction.

18. The grater of claim 1 wherein the holder is fixed to the handle, and the grating cutter is fixed to the plunger.

19. The grater of claim 3 wherein the handle comprises:
a tubular member with an axis;
a recess is disposed in the first end of the tubular member, wherein the recess is defined by two parallel edges that intersect with a circumferential edge that is disposed in a second plane of the tubular member transverse to the axis, and the two parallel edges extend axially to a first transverse plane proximate the first end of the tubular body;
the holder comprises a block received in the recess;
a space is formed in the holder for receiving the food item, said space is defined by a cylindrical wall projecting from the tubular member, the cylindrical wall extending from an inner end adjacent the grating cutter to an outer end in which the pusher retainer is received into the space, the cylindrical wall having an internal screw thread adapted to couple with a complementary external screw thread on the pusher retainer;
wherein the block comprises an external surface of like curvature to the tubular member and the cylindrical wall which extends tangentially to surfaces of the tubular member adjacent the parallel edges, the block further comprises a supporting surface in a plane transverse to a longitudinal axis of the handle for supporting the handle upright on a horizontal surface.

20. The grater of claim 19, wherein the pusher retainer is operable to adjust the space defined by the grating cutter, the holder and the pusher.
